(19) United States
(12) Patent Application Publication
(10) Pub. No.: US 2007/0079656 A1
(43) Pub. Date: Apr. 12, 2007

(54) Micro-machined acoustic wave accelerometer

(75) Inventors: James D. Cook, Freeport, IL (US); James Zt Liu, Hudson, NH (US); Steven J. Magee, Lena, IL (US)

Correspondence Address: Deanna J. Nelson, 1505 Princess Anne Road, Raleigh, NC, 27607, US

(73) Assignee: Honeywell International Inc.

(21) Appl. No.: 11/248,777

(22) Filed: Oct. 11, 2005

(51) Int. Cl. G01P 15/09

(52) U.S. Cl. 73/514.34

(57) ABSTRACT

A micro-machined acceleration sensing apparatus includes a piezoelectric substrate that functions as a propagation medium. A diaphragm is configured upon the substrate, wherein the diaphragm is etched to form one or more etched cavities. Sensing elements are formed on the diaphragm, wherein a first sensing element among the sensing elements is located on a top of the diaphragm, a second sensing element among the sensing elements is located on a side of the diaphragm, and a third sensing element among the sensing elements is located at a crystallography different orientation with respect to the first and second sensing elements, such that the substrate, the diaphragm and the plurality of sensing elements comprise a micro-machined acceleration sensing apparatus thereof that is clamped at one end of the substrate to an object under an acceleration and submitted to a force at the free end of the substrate to provide signals indicative of acceleration.

### TECHNICAL FIELD

Embodiments are generally related to sensing devices and components thereof. Embodiments also relate to acoustic wave devices. Embodiments also relate to micro-machined devices.

### BACKGROUND OF THE INVENTION

Acoustic wave sensors are utilized in a variety of sensing applications, such as, for example, temperature and/or pressure sensing devices and systems. Acoustic wave devices have been in commercial use for over sixty years. Although the telecommunications industry is the largest user of acoustic wave devices, they are also used for in other areas, such as chemical vapor detection. Acoustic wave sensors are so named because they use a mechanical, or acoustic, wave as the sensing mechanism. As the acoustic wave propagates through or on the surface of the material, any changes to the propagation path affect the characteristics of the wave.

Changes in acoustic wave characteristics can be monitored by measuring the frequency or phase characteristics of the sensor and can then be correlated to the corresponding physical quantity or chemical quantity that is being measured. Virtually all acoustic wave devices and sensors utilize a piezoelectric crystal to generate the acoustic wave. Three mechanisms can contribute to acoustic wave sensor response, i.e., mass-loading, visco-elastic and acousto-electric effect. The mass-loading of chemicals alters the frequency, amplitude, and phase and Q value of such sensors. Most acoustic wave chemical detection sensors, for example, rely on the mass sensitivity of the sensor in conjunction with a chemically selective coating that absorbs the vapors of interest resulting in an increased mass loading of the acoustic wave sensor.

Examples of acoustic wave sensors include acoustic wave detection devices, which are utilized to detect the presence of substances, such as chemicals, or environmental conditions such as temperature and pressure. An acoustical or acoustic wave (e.g., SAW/BAW) device acting as a sensor can provide a highly sensitive detection mechanism due to the high sensitivity to surface loading and the low noise, which results from their intrinsic high Q factor. Surface acoustic wave devices are typically fabricated using photolithographic techniques with comb-like interdigital transducers placed on a piezoelectric material. Surface acoustic wave devices may have either a delay line or a resonator configuration. Bulk acoustic wave device are typically fabricated using a vacuum plater, such as those made by CHA, Transat or Saunder. The choice of the electrode materials and the thickness of the electrode are controlled by filament temperature and total heating time. The size and shape of electrodes are defined by proper use of masks.

Acoustic wave devices, such as, for example, a surface acoustic wave resonator (SAW-R), a surface acoustic wave delay line (SAW-DL) device, a surface transverse wave (STW) device, or a bulk acoustic wave (BAW) device, have been utilized in mechanical quantities measurement. In such sensing applications, the sensing devices or components are typically clamped or oriented in the most sensitive direction to the mechanical quantities.

The most important difference between an acoustic wave device and a conventional wired sensor is that the acoustic wave device can store energy mechanically. Once such a device is supplied with a certain amount of energy (e.g., through RF—Radio Frequency), the device can operate for a time without any active parts (i.e., without a power supply or oscillators). Such a configuration makes it possible for acoustic waves to function in, for example, RF powered passive and wireless sensing applications.

One area where acoustic wave devices seem to have promise is in the area of accelerometers. An improved acoustic wave accelerometer is therefore disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved sensing device.

It is another aspect of the present invention to provide for an improved acoustic wave sensing device

It is a further aspect of the present invention to provide for an acoustic wave accelerometer or acceleration sensor.

The aforementioned aspects and other objectives and advantages can now be achieved as described herein. A micro-machined acceleration sensing apparatus is disclosed, which includes a piezoelectric substrate that functions as a propagation medium. A diaphragm is configured upon the substrate, wherein the diaphragm is etched to form one or more etched cavities. A plurality of sensing elements are formed on the diaphragm, wherein a first sensing element among the plurality of sensing elements is located on a top of the diaphragm, a second sensing element among the plurality of sensing elements is located on a side of the diaphragm, and a third sensing element among the plurality of sensing elements is located at a crystallography different orientation with respect to the first and second sensing elements, such that the substrate, the diaphragm and the plurality of sensing elements comprise a micro-machined acceleration sensing apparatus thereof that is clamped at one end of the substrate to an object under an acceleration and submitted to a force at the free end of the substrate to provide signals indicative of acceleration.

The second and third sensing elements among the plurality of sensing elements can provide temperature data due to the anisotropic nature of the piezoelectric temperature frequency coefficient associated with the piezoelectric substrate. Additionally, an inertial mass can be fixed at the free end of the substrate such that when the acceleration is applied to the fixed end, the acceleration is converted to a proportional force through utilization of the inertial mass fixed at the free end, wherein the proportional force interacts with an acoustic propagation through a plurality of forces applied to the propagation medium provided by the substrate, thereby generating signals indicative of the acceleration data.

Additionally, each of the first, second and third sensing elements among the plurality of sensing elements can constitute an interdigital transducer (IDT). Such an IDT can be, for example, a SAW filter electrode, wherein the frequency of the SAW filter electrode comprises data indicative of acceleration. Alternatively, such an IDT may be a SAW-R electrode, wherein the frequency of the SAW-R electrode comprises data indicative of acceleration. Likewise, the IDT may be, for example, a SAW-DL electrode, wherein the phase of the SAW DL electrode comprises data indicative of the acceleration. In general, each of the first, second and third sensing elements can function as reference electrodes.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a passive acoustic wave accelerometer having a plurality of BAW (Bulk Acoustic Wave) electrodes that can be implemented in accordance with one embodiment;

FIG. 2 illustrates a perspective view of a SAW-R acoustic wave accelerometer, in accordance with another embodiment;

FIG. 3 illustrates a perspective view of a SAW-DL acoustic wave accelerometer, in accordance with an alternative embodiment; and

FIG. 4 illustrates a side view of a micro-machined acceleration sensing apparatus that can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

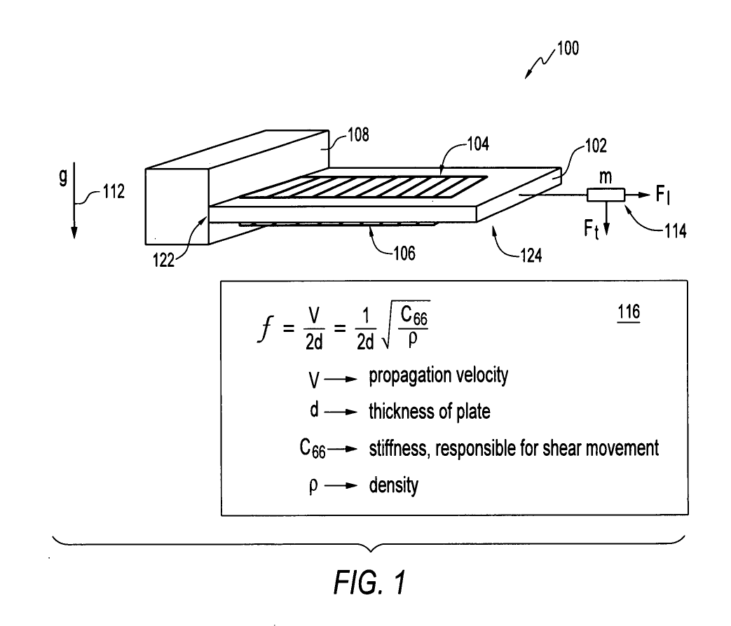

FIG. 1 illustrates a perspective view of passive acoustic wave accelerometer 100 having a plurality of BAW (Bulk Acoustic Wave) electrodes 104 and 106 that can be implemented in accordance with one embodiment. The acoustic wave accelerometer 100 is generally formed from a piezoelectric substrate 102. Electrodes 104 and 106 are configured upon substrate 102. Each electrode 104, 106 comprise an interdigital transducer (IDT). The acoustic wave accelerometer 100 generally functions as an acceleration sensor or detector.

Piezoelectric substrate 102 can be formed from a variety of substrate materials, such as, for example, quartz, lithium niobate (LiNbO₃), lithium tantalite (LiTaO₃), Li₂B₄O₇, GaPO₄, langasite (La₃Ga₅SiO₁₄), ZnO, and/or epitaxially grown nitrides such as Al, Ga or Ln, to name a few. Interdigital transducers 104 and 106 can be formed from materials, which are generally divided into three groups. First, IDT or electrodes 104, 106 can be formed from a metal group material (e.g., Al, Pt, Au, Rh, Ir Cu, Ti, W, Cr, or Ni). Second, IDT or electrodes 104, 106 can be formed from alloys such as NiCr or CuAl. Third, IDT or electrodes 104, 106 can be formed from metal-nonmetal compounds (e.g., ceramic electrodes based on TiN, CoSi₂, or WC). In the configuration depicted in FIG. 1, IDT or electrodes 104, 106 generally comprise BAW electrodes. IDT or electrode 104 is formed on one side of substrate 102, while IDT or electrodes 106 is formed on the opposite side of substrate 102.

Object 108 represents a component or device under acceleration. Mass and transverse and later forces thereof are illustrated by block 114. In general block 114 represents an inertial mass fixed at the free end 124 of plate 102. The transverse force is labeled Fₜ while the lateral force is labeled Fₗ. Gravity is indicated generally by arrow 112 in FIG. 1. Additionally, the following equation (1) is illustrated in block 116:

$$f = \frac{V}{2 d} = \frac{1}{2 d} \sqrt{\frac{{C}_{GG}}{ρ}} \qquad ( 1 )$$

Equation (1) relates generally to the values associated with the function of accelerometer 100. Thus, f represents force and V represents propagation velocity. The variable d on the other hand represents the thickness of the plate or substrate 102. The variable C_{GG} represents stiffness, which is responsible for shear movement. Finally, the variable ρ represents density.

In the configuration depicted in FIG. 1, the operations of accelerometer 100 is generally based on the changes produced in the acoustic phase velocity by the presence of a static or a slowly varying mechanical polarization applied to the propagation medium. The basic acoustic wave acceleration sensor or accelerometer 100 comprises substrate or plate 102 for acoustical wave propagation. The sensor or accelerometer 100 is clamped at one end 122 thereof and submitted to a force at a free end 124. When acceleration is applied, the resulting values are converted to a proportional force through the use of inertial mass fixed at the free end 124 of the plate as indicated generally by block 114. The applied force interacts with the acoustic propagation through three components applied to the propagation medium: two bending forces that are perpendicular to the propagation surface and transverse thereof, along with a longitudinal or compression force.

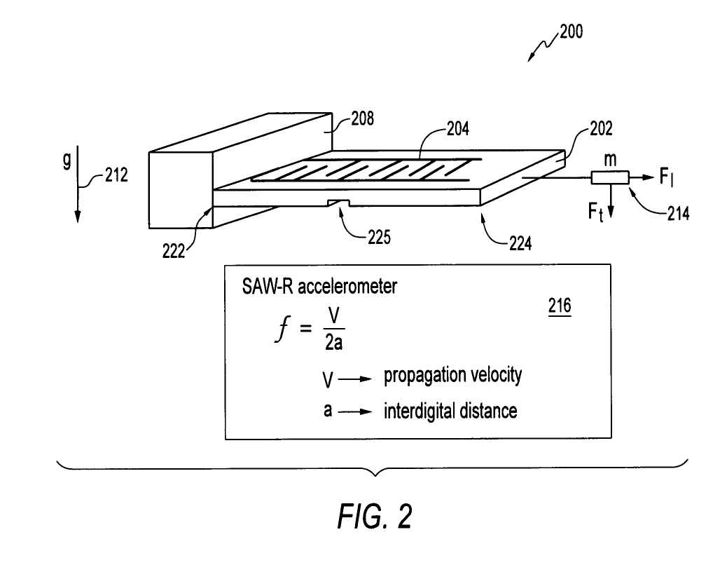

FIG. 2 illustrates a perspective view of a SAW-R acoustic wave accelerometer 200, which can be implemented in accordance with another embodiment. The acoustic wave accelerometer 200 is generally formed from a piezoelectric substrate 202. Electrode 204 is configured upon substrate 202 and generally comprises an interdigital transducer (IDT). The SAW-R acoustic wave accelerometer 200 generally functions as an acceleration sensor or detector. Piezoelectric substrate 202 can be formed from a variety of substrate materials, such as, for example, quartz, lithium niobate (LiNbO₃), lithium tantalite (LiTaO₃), Li₂B₄O₇, GaPO₄, langasite (La₃Ga₅SiO₁₄), ZnO, and/or epitaxially grown nitrides such as Al, Ga or Ln, to name a few. IDT or electrode 204 can be formed from materials, which are generally divided into three groups. First, IDT or electrode 204 can be formed from a metal group material (e.g., Al, Pt, Au, Rh, Ir Cu, Ti, W, Cr, or Ni). Second, IDT or electrode 204 can be formed from alloys such as NiCr or CuAl. Third, IDT or electrode 204 can be formed from metal-nonmetal compounds (e.g., ceramic electrodes based on TiN, CoSi₂, or WC). In the configuration depicted in FIG. 1, IDT or electrode 204 generally constitutes a SAW-R electrode, although it can be appreciated that other types of acoustic wave electrodes may be utilized in place of SAW-R.

In FIG. 2, object 208 represents a component or device under acceleration. Mass and transverse and later forces thereof are illustrated by block 214. In general block 214 represents an inertial mass fixed at the free end 224 of plate 202. The transverse force is labeled Fₜ while the lateral force is labeled Fₗ. Gravity is indicated generally by arrow 112 in FIG. 2. Additionally, the following equation (2) is illustrated in block 216:

$$f = \frac{V}{2 a} \qquad ( 2 )$$

Equation (2) relates generally to the values associated with the function of accelerometer 200. Thus, f represents force and V represents propagation velocity. The variable α on the other hand represents the interdigital distance. That is the distance of IDT electrode 204 (i.e. a SAW-R electrode).

In the configuration depicted in FIG. 2, the operations of accelerometer 200 are generally based on changes produced in the acoustic phase velocity by the presence of a static or a slowly varying mechanical polarization applied to the propagation medium. The basic acoustic wave acceleration sensor or accelerometer 200 comprises substrate or plate 202 for acoustical wave propagation. The sensor or accelerometer 200 is clamped at one end 222 thereof and submitted to a force at a free end 224. When acceleration is applied, the resulting values are converted to a proportional force through the use of inertial mass fixed at the free end 224 of the plate as indicated generally by block 214. The applied force interacts with the acoustic propagation through three components applied to the propagation medium: two bending forces that are perpendicular to the propagation surface and transverse thereof, along with a longitudinal or compression force.

The accelerometer 200 can also be configured to include a micromachined channel 225, which may be rectangular or circular in shape and located on the backside of substrate 202 and beneath one or more of the interdigital transducers 204, such that a mass within the etched or micro-machined rectangular or circular frame-shaped channel 225 (or diaphragm) possesses a high sensitivity to the acceleration when the acceleration is applied to the acoustic wave device 200.

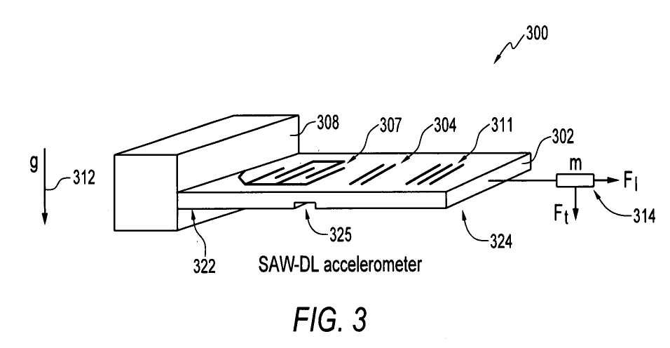

FIG. 3 illustrates a perspective view of a SAW-DL accelerometer 300, which can be implemented in accordance with an alternative embodiment. The SAW-DL accelerometer 300 (i.e., acceleration sensor) includes a plurality of SAW-DL electrodes or IDTs 307, 309, and 311 wherein are generally formed upon a piezoelectric substrate 302.

Piezoelectric substrate 202 can be formed from a variety of substrate materials, such as, for example, quartz, lithium niobate (LiNbO₃), lithium tantalite (LiTaO₃), Li₂B₄O₇, GaPO₄, langasite (La₃Ga₅SiO₁₄), ZnO, and/or epitaxially grown nitrides such as Al, Ga or Ln, to name a few. The SAW-DL electrodes or IDTs 307, 309, 311 can be formed from materials, which are generally divided into three groups. First, SAW-DL electrodes or IDTs 307, 309, 311 can be formed from a metal group material (e.g., Al, Pt, Au, Rh, Ir Cu, Ti, W, Cr, or Ni). Second, SAW-DL electrodes or IDTs 307, 309, 311 can be formed from alloys such as NiCr or CuAl. Third, SAW-DL electrodes or IDTs 307, 309, 311 can be formed from metal-nonmetal compounds (e.g., ceramic electrodes based on TiN, CoSi₂, or WC).

Object 308 represents a component or device under acceleration. Mass and transverse and later forces thereof are illustrated by block 314. In general block 314 represents an inertial mass fixed at the free end 324 of plate 302. The transverse force is labeled Fₜ while the lateral force is labeled Fₗ. In the configuration depicted in FIG. 3, the operations of accelerometer 300 are generally based on the changes produced in the acoustic phase velocity by the presence of a static or a slowly varying mechanical polarization applied to the propagation medium.

The basic acoustic wave acceleration sensor or accelerometer 300 comprises substrate or plate 302 for acoustical wave propagation. The sensor or accelerometer 300 is generally clamped at one end 322 thereof and submitted to a force at a free end 324. When acceleration is applied, the resulting values are converted to a proportional force through the use of inertial mass fixed at the free end 324 of the plate as indicated generally by block 314. The applied force interacts with the acoustic propagation through three components applied to the propagation medium: two bending forces that are perpendicular to the propagation surface and transverse thereof, along with a longitudinal or compression force.

The accelerometer 300 can also be configured to include a micromachined channel 325, which may be rectangular or circular in shape and located on the backside of substrate 302 and beneath one or more of the interdigital transducers 307, 304, 311, such that a mass within the etched or micro-machined rectangular or circular frame-shaped channel 325 (or diaphragm) possesses a high sensitivity to the acceleration when the acceleration is applied to the acoustic wave device 300.

Based on the foregoing it can be appreciated that an acoustic wave accelerometer can be arranged in a variety of designs, such as, BAW, SAW-R and/or SAW-delay line configurations. Such devices can operate with a high degree of reliability. The SAW-DL acoustic wave accelerometer illustrated in FIG. 3, for example, can provide for low power consumption and good sensitivity. The BAW accelerometer 100 depicted in FIG. 1 provides for the highest sensitivity of the three devices illustrated herein. The temperature dependence of each sensor 100, 200, 300 is reproducible and in most cases, thermal strain from the mounting thereof dominates thermal variations of material properties. This temperature dependence can be eliminated, however, by using a two-sensor configuration. The acceleration sensors 100, 200, 300 are thus sensitive to transverse and longitudinal forces. The transverse forces induce stronger effects.

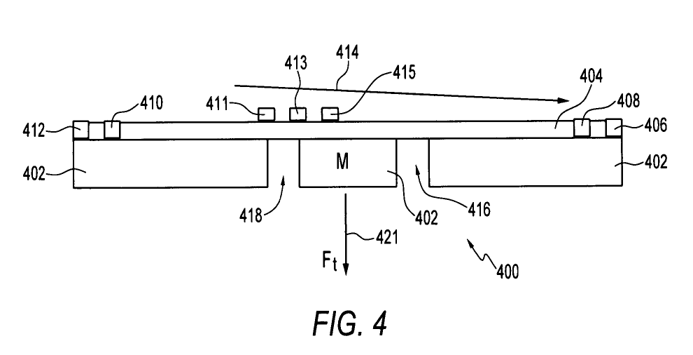

FIG. 4 illustrates a side view of a micro-machined acceleration sensing apparatus 400 that can be implemented in accordance with a preferred embodiment. Apparatus 400 generally constitutes a micro-machined acoustic wave accelerometer and includes a piezoelectric substrate 402 that functions as a propagation medium. A diaphragm 404 is configured upon the substrate 402. The diaphragm 404 can be etched to form one or more etched cavities 418, 416. A plurality of sensing elements 406, 408, 410, 412, 411, 413, 415 can be formed on the diaphragm. In general, sensing elements 411, 413, 415 can be located on top of the diaphragm 404. Sensing elements 412, 406 can be configured at the sides of the diaphragm 404. Sensing elements 410, 408 can be located at a crystallography different orientation with respect to the other sensing elements 412, 406 and 411, 413, 415. The substrate 402, the diaphragm 404 and the sensing elements 406, 408, 410, 412, 411, 413, 415 constitute a micro-machined acceleration sensing apparatus that can be clamped at one end of the substrate 402 to an object under an acceleration and submitted to a force at the free end of the substrate 402 to provide signals indicative of acceleration, in a manner similar to that depicted in FIGS. 1-3.

In general, sensing elements 412, 406 and 410, 408 can provide temperature data due to the anisotropic nature of the piezoelectric temperature frequency coefficient associated with the piezoelectric substrate 402. Additionally, an inertial mass can be fixed at a free end of the substrate 402 such that when the acceleration is applied to the fixed end, the acceleration is converted to a proportional force through utilization of the inertial mass fixed at the free end, wherein the proportional force interacts with an acoustic propagation through a plurality of forces applied to the propagation medium provided by the substrate 402, thereby generating signals indicative of the acceleration data. Such a configuration is generally consistent with the configuration depicted in FIGS. 1-3.

Additionally, each of the sensing elements can constitute an interdigital transducer (IDT). Such an IDT can be, for example, a SAW filter electrode, wherein the frequency of the SAW filter electrode comprises data indicative of acceleration. Alternatively, such an IDT may be a SAW-R electrode, wherein the frequency of the SAW-R electrode comprises data indicative of acceleration. Likewise, such an IDT may be, for example, a SAW-DL electrode, wherein the phase of the SAW DL electrode comprises data indicative of the acceleration. In general, each of the sensing elements 406, 408, 410, 412, 411, 413, 415 can function as reference electrodes.

The configuration depicted in FIG. 4 is generally directed toward an accelerometer 400 that includes a plate or substrate 402 for acoustical wave propagation. The sensor 400 can be clamped at one end and submitted to a force at a free end. When acceleration is applied, this force converted to a proportional force through the use of inertial mass fixed at the free end of the plate or substrate 402. The applied force interacts with the acoustic propagation through the three components applied to the propagation medium: Two bending forces, perpendicular to the propagation surface and transverse to that, i.e., a longitudinal one (e.g., compressional).

The micro-machined acoustic wave accelerometer 400 can be constructed in the context of different designs, such as that of, for example, a BAW, SAW-resonator, a SAW-filter or a SAW-delay line. Such designs can operate passively, wirelessly and reliably. The SAW-DL has the highest measurement rate, but has lower accuracy and requires very high transceiver power due to its high insertion loss. The SAW-R has low power consumption and good sensitivity. The BAW has the highest sensitivity and with the highest cost. The temperature dependence of each sensor is reproducible, and in most cases thermal strain from the mounting dominates thermal variations of materials properties. This, however, can be eliminated by using reference sensors such as, for example, sensing elements 406, 408, 410, 412, 411, 413, 415. Note that arrow 421 depicted in FIG. 4 indicates that mass is created by a micro-machined or etched channel 418 and/or 402 and/or the etched diaphragm 404.

The basic configuration for apparatus 400 follows a general outline as follows: a sensor 1 is located on top of the etched diaphragm 404; a sensor 2 is on the side, while sensor 3 is located at the different crystallography angle with sensor 1 and sensor 2. Because of the an-isotropic of the piezoelectric temperature frequency coefficient, the sensor 2 and sensor 3 can provide temperature information.

The accelerometer 400 can be formed utilizing micro-machining techniques. A number of processing steps can be followed for the fabrication of accelerometer 400. An example of such processing steps is provided below, in the context, of for example, a SAW-based accelerometer 400.
1. Micro-roughness evaluation of as-received double-side chemical-polished quartz SAW wafers;
2. Wafer cleaning;
3. Deposition of thin metal layer used as resist mask in next step;
4. Photolithographic process for channel-gap forming, required for metal path to pass from SAW surface to external connection(s);
5. RIE etching of channel-gap;
6. Metal removal;
7. Wafer cleaning;
8. Deposition of the thin film layer utilized as a resist mask for titanium implantation;
9. Photolithographic process for titanium implantation;
10. Titanium implantation for buried conductive paths forming;
11. Deposition of the metal layer used for SAW electrode forming and external contact;
12. Photolithographic process for metal patterning;
13. Metal etching;
14. Wafer cleaning;
15. Hydrophilisation treatment of the quartz SAW wafer in boiled, concentrated HNO₃ for 30-50 minutes;
16. Rinsing in Dl water followed by drying;
17. Cleaning in Megasonic RCA 1 solution (NH₄OH:H₂O₂:H₂O=1:1:5) for 10 minutes, followed by HCl:H₂O₂:H₂O=1:1:6 for 10 minutes; and
18. Drying.

Upon completion of the processing steps indicated above, a similar set of processing steps can be implemented upon another quartz wafer to form the quartz base plate. When the two quartz wafers are ready for direct bonding, wafer dicing and chip assembling can be processed, as indicated below:
1. Contact and alignment of the quartz SAW wafer and quartz base plate;
2. Thermal annealing in N₂ for 1 hour at T<450° C., wherein the temperature should be ramped up and down with approximately 10° C./min;
3. Bonding control, wherein a “crack opening” method is utilized via a 50 mm blade;
4. Partial wafer dicing (i.e., a cut of thickness equal to the thickness of the quartz SAW wafer, and only in one direction);
5. Entire thickness dicing of the bonded wafers on the inter-chip spaces of the AQP microstructure;
6. Chip bonding with special resin on the package base plate;
7. Dispensing of the conductive resin for metal contacting from both chips;
8. Wire bonding;
9. Dispensing of the protective resin; and
10. Capping and welding.

In general, accelerometer 400 can be configured utilizing standard micro-electromechanical systems (MEMS) fabrication techniques. Note that the term MEMS generally refers to a technology that integrates complex electromechanical elements and processing circuitry on a substrate.

An acceleration sensor may be configured that includes an acoustic wave device including a plate that functions as a propagation medium and at least one interdigital transducer configured upon the plate. An antenna can be integrated with the acoustic wave device, wherein the antenna communicates with interdigital transducer(s). The antenna receives and transmits signals indicative of acceleration data, wherein the acoustic wave device is clamped at one end of the plate to an object under acceleration and submitted to a force at the free end of the plate. Additionally, as indicated herein, an etched or micro-machined circular or rectangular frame-shaped channel or diaphragm could be located on a back side of the wireless acoustic wave accelerometer substrate 202, 302 or 402, located beneath at least one interdigital transducer, such that a mass within the etched or micro-machined rectangular or circular frame-shaped channel or diaphragm possesses a high sensitivity to the acceleration when the acceleration is applied to the acoustic wave device. The acceleration can be converted to a proportional force through utilization of the mass fixed at the free end of the plate, wherein the proportional force interacts with an acoustic propagation through a plurality of forces applied to the propagation medium, thereby generating signals indicative of the acceleration data for wireless transmission from the antenna.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An acceleration sensing apparatus, comprising:
a piezoelectric substrate that functions as a propagation medium;
a diaphragm configured upon said substrate, wherein said diaphragm is etched to form at least one etched cavity thereof; and
a plurality of sensing elements formed on said diaphragm, wherein a first sensing element among said plurality of sensing elements is located on a top of said diaphragm, a second sensing element among said plurality of sensing elements is located on a side of said diaphragm, and a third sensing element among said plurality of sensing elements is located at a crystallography different orientation with respect to said first and second sensing elements, such that said substrate, said diaphragm and said plurality of sensing elements comprise a micro-machined acceleration sensing apparatus thereof that is clamped at one end of said substrate to an object under an acceleration and submitted to a force at said free end of said substrate to provide signals indicative of acceleration.

2. The apparatus of claim 1 wherein said second and third sensing elements among said plurality of sensing elements provide temperature data due to an anisotropic feature of a piezoelectric temperature frequency coefficient associated with said substrate.

3. The apparatus of claim 1 further comprising an inertial mass fixed at said free end of said substrate such that when said acceleration is applied to said fixed end, said acceleration is converted to a proportional force through utilization of said inertial mass fixed at said free end, wherein said proportional force interacts with an acoustic propagation through a plurality of forces applied to said propagation medium provided by said substrate, thereby generating signals indicative of said acceleration data.

4. The apparatus of claim 1 wherein each of said first, second and third sensing elements among said plurality of sensing elements comprises an interdigital transducer (IDT).

5. The apparatus of claim 4 wherein said IDT comprises a SAW filter electrode, wherein a frequency of said SAW filter electrode comprises data indicative of said acceleration.

6. The apparatus of claim 4 wherein said IDT comprises a SAW-R electrode, wherein a frequency of said SAW-R electrode comprises data indicative of said acceleration.

7. The apparatus of claim 4 wherein said IDT comprises a SAW-DL electrode, wherein a phase of said SAW DL electrode comprises data indicative of said acceleration.

8. The apparatus of claim 1 wherein each of said first, second and third sensing elements among said plurality of sensing elements comprises a reference electrode.

9. An acceleration sensing apparatus, comprising:
a piezoelectric substrate that functions as a propagation medium;
a micromachined mass configured upon said substrate, wherein said micromachined mass is etched to form at least one etched cavity thereof; and
a plurality of sensing elements formed on said micromachined mass, wherein a first sensing element among said plurality of sensing elements is located on a top of said micromachined mass, a second sensing element among said plurality of sensing elements is located on a side of said micromachined mass, and a third sensing element among said plurality of sensing elements is located at a crystallography different orientation with respect to said first and second sensing elements, such that said substrate, said micromachined mass and said plurality of sensing elements comprise a micro-machined acceleration sensing apparatus thereof that is clamped at one end of said substrate to an object under an acceleration and submitted to a force at said free end of said substrate to provide signals indicative of acceleration.

10. The apparatus of claim 9 wherein said micromachined mass comprises a sensor diaphragm.

11. The apparatus of claim 9 wherein said micromachined mass is configured to include a channel formed on a backside of said substrate.

12. The apparatus of claim 9 wherein said micromachined mass is rectangular in shape.

13. The apparatus of claim 9 wherein said micromachined mass is circular shape

14. The apparatus of claim 9 wherein said micromachined mass possesses a high sensitivity to said acceleration when said acceleration is applied to said acoustic device.

15. A method for forming a micro-machined acceleration sensing apparatus, comprising:
providing a piezoelectric substrate that functions as a propagation medium;
configuring a diaphragm configured upon said substrate, wherein said diaphragm is etched to form at least one etched cavity thereof; and
forming a plurality of sensing elements formed on said diaphragm, wherein a first sensing element among said plurality of sensing elements is located on a top of said diaphragm, a second sensing element among said plurality of sensing elements is located on a side of said diaphragm, and a third sensing element among said plurality of sensing elements is located at a crystallography different orientation with respect to said first and second sensing elements, such that said substrate, said diaphragm and said plurality of sensing elements comprise a micro-machined acceleration sensing apparatus thereof that is clamped at one end of said substrate to an object under an acceleration and submitted to a force at said free end of said substrate to provide signals indicative of acceleration.

16. The method of claim 15 wherein said second and third sensing elements among said plurality of sensing elements provide temperature data due to an anisotropic feature of a piezoelectric temperature frequency coefficient associated with said substrate.

17. The method of claim 15 further comprising fixing an inertial mass at said free end of said substrate such that when said acceleration is applied to said fixed end, said acceleration is converted to a proportional force through utilization of said inertial mass fixed at said free end, wherein said proportional force interacts with an acoustic propagation through a plurality of forces applied to said propagation medium provided by said substrate, thereby generating signals indicative of said acceleration data.

18. The method of claim 15 wherein each of said first, second and third sensing elements among said plurality of sensing elements comprises an interdigital transducer (IDT).

19. The method of claim 18 wherein said IDT comprises a SAW filter electrode, wherein a frequency of said SAW filter electrode comprises data indicative of said acceleration.

20. The method of claim 18 wherein said IDT comprises a SAW-R electrode, wherein a frequency of said SAW-R electrode comprises data indicative of said acceleration.

21. The method of claim 18 wherein said IDT comprises a SAW-DL electrode, wherein a phase of said SAW DL electrode comprises data indicative of said acceleration.
